(19) United States
(12) Patent Application Publication
(10) Pub. No.: US 2020/0390094 A1
(43) Pub. Date: Dec. 17, 2020

(54) INSECT-RESISTANT FABRICS HAVING A COMBINATION OF ACTIVE INGREDIENTS

(71) Applicant: ELEVATE TEXTILES, INC., GREENSBORO, NC (US)

(72) Inventor: Kiarash Arangdad, GREENSBORO, NC (US)

(21) Appl. No.: 16/899,996

(22) Filed: Jun. 12, 2020

Related U.S. Application Data
(60) Provisional application No. 62/861,481, filed on Jun. 14, 2019.

(51) Int. Cl. A01N 25/34; A01N 37/08; A01N 31/06; A01N 65/28; A01N 65/22; A01N 65/44; A01N 25/28; A01N 25/10

(52) U.S. Cl. CPC A01N 25/34; A01N 37/08; A01N 31/06; A01N 25/10; A01N 65/22; A01N 65/44; A01N 25/28; A01N 65/28

(57) ABSTRACT

The present disclosure is directed to insect-resistant fabrics or garments and methods for making the same. The insect-resistant fabrics or garments include a combination of actives such as one or more insect repellants and an insecticide. As an example, an insect-resistant fabric in accordance with the disclosure can include a base fabric (e.g., polyester) having been treated to include an insect repellant (e.g., an essential oil) in a first region of the fabric, and an insecticide (e.g., permethrin) in second region of the base fabric. The combination of multiple actives which can have different modes of action is shown herein to provide improved insect-resistant efficacy. Additionally, certain insect-resistant fabrics disclosed herein can also demonstrate durability when exposed to wear such as laundering the garment.

### RELATED APPLICATIONS

The present application is based on and claims priority to U.S. Provisional Patent application Ser. No. 62,861,481, filed on Jun. 14, 2019, which is incorporated herein by reference.

### BACKGROUND

Vector borne diseases cause thousands of deaths annually where many of these diseases are preventable through protective measures. There are some commercially available spray or lotion insect repellents which can be topically applied to skin or clothing, but these are not durable to washes. Insecticide treated fabric and/or garment are intended to reduce biting by mosquitos and possibly other insects. Synthetic pyrethroids, such as permethrin, exhibit knockdown and kill activity with long term protection for users. It has been applied to the garment and/or fabrics by dipping, spraying, and polymer coating methods. For example, garments have been impregnated with permethrin in an industrial washing machine having a rotatable drum. U.S. Pub. No. 2012/0100198A1 discloses permethrin-treated garment where the garment has been sprayed with an aqueous emulsion which contains approximately 40% by weight permethrin. Regarding fabric application, U.S. Pub. No. 2010/0119720A1 teaches methods for insecticidal impregnation of netting and fabrics. In other examples, pyrethroids were added to fabrics during the dyeing process where the fabric is immersed in a dye bath containing permethrin (exhaust dyeing solution). The major challenge of permethrin-treated textiles has been wash durability and persistency. Poor washing fastness of pyrethroid-treated fabrics has been enhanced by adding polymeric binding and crosslinking agents in the finishing formula. Decomposition of pyrethroid into a nonactive insecticidal product in the presence of ultraviolet light have still negative impacts on the persistency and efficacy of treated fabrics. However, degradation of pyrethroid, such as permethrin in presence of light and oxygen, can be prevented by including a barrier layer, as taught in U.S. Pat. No. 5,252,387.

There is still serious threat to wearer protection when pyrethroids-treated fabric and garments do not prevent vector mosquitoes from landing. Repellent active ingredients interfere in the attraction mechanism of insects. Unlike insecticide materials, insect repellent agents are used to drive away insects, so the agents act not as contact poison to kill insects but to repel them before probing and biting. In one example, an aqueous dispersion of an amine insect repellent such as N, N′-diethyl-m-toluamide (DEET), with substituted organosilane and silanol functional polymer, was applied on fabric. Spatial repellants containing plant-based ingredients, such as citronella oil, rosemary oil and eucalyptus oil, have gained popularity among consumers when they are perceived to be safe and environmentally sustainable. For instance, a strip of finished fabric (polyester/cotton) with aromatic oils was attached to a headwear in order to provide bite prevention. The efficacy and longevity of these natural repellents is restricted due to the volatility of its components.

Prior bite protective substrates do not provide long lasting concurrent repellency and insecticidal efficacies. There remains a need for enhanced bite protective fabric/garment. The present disclosure provides examples to address certain shortcomings in pyrethroid only impregnated substrates by utilizing a combination of active ingredients.

### SUMMARY OF THE INVENTION

The present disclosure is directed to insect-resistant fabrics or garments that can include a combination of actives such as an insect repellant and optionally an insecticide. As an example, an embodiment of the disclosure can include an insect-resistant fabric or garment made from a base fabric (e.g., polyester.) The base fabric having been treated to include an insect repellant (e.g., an essential oil) in a first region of the fabric, and, optionally, an insecticide (e.g., permethrin) in a second region of the base fabric.

Aspects of the present disclosure can also include methods for producing an insect-resistant fabric.

Another aspect of the present disclosure can include a method for treating a fabric or a garment to enhance insect resistance (e.g., bite protection.)

A further aspect of the present disclosure can include insect-resistant fabrics or garments that demonstrate enhanced insect resistance after applying wear (e.g., washing the garment) and methods to produce the same.

### BRIEF DESCRIPTION OF THE DRAWINGS

A full and enabling disclosure of the present invention, including the best mode thereof to one skilled in the art, is set forth more particularly in the remainder of the specification, which includes reference to the accompanying figures.

FIGS. 1A and 1B illustrate images of fabrics in accordance with example embodiments of the disclosure.

FIGS. 2A and 2B illustrate images of fabrics displaying microcapsule durability in accordance with example embodiments of the disclosure.

FIG. 3 illustrates one embodiment of a fabric treated in accordance with the present disclosure.

Repeat use of reference characters in the present specification and drawings is intended to represent the same or analogous features or elements of the present invention.

### DETAILED DESCRIPTION

Reference now will be made to the embodiments of the disclosure, one or more examples of which are set forth below. Each example is provided by way of an explanation of the invention and not as a limitation. In fact, it will be apparent to those skilled in the art that various modifications and variations can be made in the disclosed embodiments without departing from the scope or spirit of the invention. For instance, features illustrated or described as one embodiment can be used on another embodiment to yield still a further embodiment. Thus, it is intended that the present invention cover such modifications and variations as come within the scope of the appended claims and their equivalents. It is to be understood by one of ordinary skill in the art that the present discussion is a description of exemplary embodiments only and is not intended as limiting the broader aspects of the present invention, which broader aspects are embodied exemplary constructions.

Generally speaking, the present disclosure is directed to insect resistance fabrics and garments which can be formed by treating a base fabric or garment with one or more active ingredients such as one or more natural or synthetic insect repellants and, optionally, a natural or synthetic insecticide. By using a combination of ingredients that can include one or more insect repellants in addition to an insecticide, the embodiments disclosed herein can provide advantages such as increased barrier efficacy, while also demonstrating durability of the active materials over repeated wear (e.g., time and/or washings.) Alternatively, the present disclosure can be directed to a fabric treated only with an insect repellant that provides significant protection from insects, even after being laundered several laundry cycles.

As an example, an insect-resistant fabric formed in accordance with disclosure can include an insect repellant (e.g., p-menthane 3,8-diol, lemon eucalyptus extract, citronella extract, etc.) and optionally an insecticide (e.g., permethrin) bound or otherwise incorporated in a base fabric to form the insect-resistant fabric. In certain embodiments, the insect repellant may be encapsulated which can be used to further enhance the durability of the active materials.

The base fabric, textile substrate, or garment to be treated in accordance with the invention is not limited as to type. Natural and synthetics, such as cotton, rayon, linen, wool, polyester, polyamides (“nylons”), acrylic, cellulose acetate, polyaramide, and polypropylene fabric, as well as blends of these (e.g., cotton and polyester, cotton and nylon) are suitable fabrics in accordance with this disclosure. Additionally, leathers, both natural and man-made, are also contemplated as a garment material suitable for impregnation with an insect repellant and/or an insecticide according to the invention. In an example embodiment of the disclosure, the base fabric includes a polyester fabric. In another example embodiment, the base fabric includes a nylon or a nylon blend. In a further example embodiment, the base fabric includes or otherwise incorporates polyaramides such as poly meta-aramid and poly para-aramid.

An example embodiment of the disclosure can include an insect-resistant fabric. In general, the insect-resistant fabric includes a base fabric treated so that a portion (e.g., a first region) of the base fabric includes an insect repellant. Additionally, the insect-resistant fabric may include another portion (e.g., a second region) of the base fabric that includes an insecticide. For insect-resistant fabrics produced in accordance with the disclosure, the portion including the insecticide and the portion including the insect repellant can overlap entirely (e.g., the first region and the second region are the same or the first region includes all of the second region), partially (e.g., the first region includes some of the second region), or not at all (e.g., the first region includes none of the second region.)

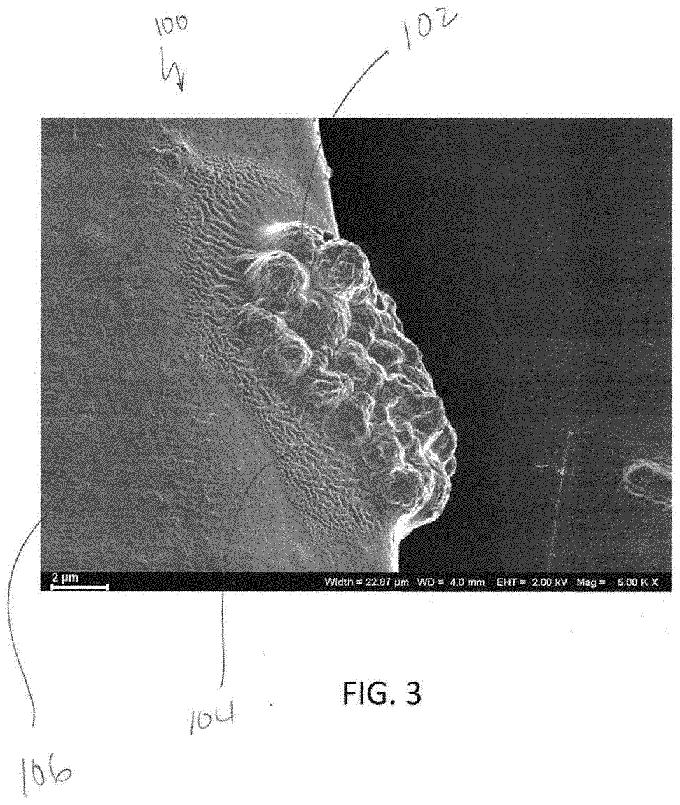

Referring to FIG. 3, for instance, one embodiment of a fabric that has been treated with both an insect repellant and an insecticide is illustrated. In one embodiment, for instance the insect repellant can be applied to the fabric in the form of microcapsules, while the insecticide can serve as a binder for the insect repellant. Referring to FIG. 3, for instance, a fiber or portion of a fabric 106 is illustrated. As shown, applied to the fiber 106 are a plurality of microcapsules 102 containing an insect repellant. Surrounding the microcapsules 102 containing the insect repellant is an insecticide 104. This unique structure provides dual protection against insects. In addition, both the insecticide and insect replant can be applied to the fabric in a manner that produces an extremely durable treatment.

Generally, the insecticide can include any compound or combination of compounds that function to kill an insect. For embodiments of the disclosure, the insecticide may have biocidal activity beyond targeting insects (e.g., the insecticide may also target arachnids, nematodes, or annelids.) In certain embodiments, the insecticide can be a broad-spectrum insecticide, such that the compound or combination of compounds can function to kill various insect species (e.g., mosquitos, ants, beetles, flies, bees, etc.) In some embodiments, the insecticide can be a specific insecticide, such that the compound or combination of compounds can function to kill only a certain insect species.

A non-limiting example of an insecticide in accordance with the disclosure includes pyrethroid compounds. Example pyrethroid compounds include: Allethrin, Bifenthrin, Cyfluthrin, Cypermethrin, Cyphenothrin, Deltamethrin, Esfenvalerate, Etofenprox, Fenpropathrin, Fenvalerate, Flucythrinate, Flumethrin, Imiprothrin, lambda-Cyhalothrin, Metofluthrin, Permethrin, Resmethrin, Silafluofen, Sumithrin, tau-Fluvalinate, Tefluthrin, Tetramethrin, Tralomethrin, Transfluthrin,

Generally, the insect repellant can include any compound or combination of compounds that act to disrupt an insect's ability to target a surface or that act to discourage an insect from landing on a surface. For embodiments of the disclosure, the insect repellant can include a natural repellant (e.g., an essential oil), an active compound derived from the natural repellant, a synthetic repellant (e.g., N,N-diethyl-m-toluamide), or a combination thereof. As an example, lemon eucalyptus essential oil includes the active compound menthane 3,8-diol. Thus, an example insect-resistant fabric, in accordance with the disclosure, can include lemon eucalyptus essential oil and/or menthane 3,8-diol incorporated into a base fabric along with an insecticide.

A non-limiting list of natural repellants in accordance with the disclosure includes the essential oils: citronella, lemon eucalyptus, lavender, peppermint, sweet basil, catnip, tea tree, rosemary, and sage.

A non-limiting list of synthetic repellants in accordance with the disclosure includes: Methyl anthranilate and other anthranilate-based insect repellents, Benzaldehyde, N,N-Diethyl-m-toluamide, Dimethyl carbate, Dimethyl phthalate, Ethylhexanediol, 1-(1-Methylpropoxycarbonyl)-2-(2-hydroxyethyl) piperidine, Butopyronoxyl, Ethyl butylacetylaminopropionate, and 2,3,5,6-Tetrafluoro-4-(methoxymethyl) benzyl 2,2-dimethyl-3-(prop-1-en-1-yl)cyclopropanecarboxylate.

For certain embodiments, the insect repellant may be contained within a microcapsule. In these embodiments, the microcapsule acts to provide a barrier to diminish the release of the insect repellant and improve durability due to fabric/garment wear such as laundering or time. By including the insect repellant in a microcapsule, repellants that have a higher vapor pressure can be incorporated into insect-resistant fabrics or garments that demonstrate insect-resistant efficacy, even after multiple wash cycles.

Microcapsules that can be used in accordance with the disclosure can be made from a variety of base materials and can be modified to adjust particle size, ease of breakage, or other microcapsule properties. Generally, a microcapsule includes a shell made from a polymer and a core that includes the insect repellant. When the shell is disrupted (e.g., through mechanical breakage), the insect repellant contained in the core can be released. In one aspect, the microcapsules can be described by a shell thickness. Thicker shells can reduce microparticle breakage which can lead to longer repellant efficacy. However, if the shell is too thick, breakage may be minimal such that sufficient insect repellant may not be released. Thus, modifications to the microcapsule shell thickness or the use of a distribution of microcapsules having different shell thicknesses may be incorporated in certain embodiments to adjust durability of the actives or to improve insect-resistant efficacy.

Another aspect of the microcapsules can include a capsule size. For example, microcapsules that can be used in accordance with the disclosure can have a particle size (as characterized by particle diameter) of about 0.5 micron to about 100 micron, such as 1 μm to 50 μm, 5 μm to 40 μm, or 10 μm to 30 μm. In some implementations, a narrow capsule size range can be used, such as about 1 micron to about 3 micron.

In certain embodiments, the insect-resistant fabric may further include one or more binding agents to improve retention of the insecticide, the insect repellant, or both after a wash cycle. Binding agents have been shown to improve wash durability for garments that only include insecticide, see for example U.S. Pat. No. 7,625,411, which is incorporated herein in its entirety by reference.

Several non-limiting examples of a binding agent that can be used in accordance with this disclosure include: a polyester polymer binder, a polyetheramide polymer binder, a polyurethane binder, a DMDHEU/polyol polymer, a cross-linking agent (e.g., a silane), and a dye fixative agent. For example, an insect-resistant fabric in accordance with this disclosure can include a polyurethane binder to improve at least the durability or retention of the insecticide. Additionally, or alternatively, the insect-resistant fabric can include the cross-linking agent 3-glycidoxypropyltrimethoxysilane, or a derivative thereof, to improve at least the durability or retention of the microcapsule including the insect repellant.

For certain insect-resistant fabrics and garments in accordance with the disclosure, the addition of a binding agent can be used to improve the retention of the insect repellant in the fabric or garment such that an effective amount of the insect repellant is present after a number of wash cycles. As used herein, an effective amount of the insect repellant can be used to indicate that at least a detectable amount (e.g., as measured by imaging of the microparticles or using a spectroscopy technique) of the insect repellant remains in the garment.

In some implementations, the effective amount may be specified as a percentage loss relative to the initial amount of insect repellant. For example, an insect-resistant fabric of the present disclosure can include a fabric treated with a solution containing microparticles that each include an insect repellant which upon initial imaging displayed a number of microparticles (e.g., 100) over the image area (e.g., per square micron). After washing the fabric over 10 cycles and reimaging the washed insect-resistant fabric, the new images displayed another number of microparticles (e.g., 50) over the same area. Thus, over 10 wash cycles, the imaging displayed a 50% reduction in the microparticles containing the insect repellant.

As used herein, a wash cycle or laundry cycle can be in accordance with NFPA test 1971, 8-1.2 (or AATCC TM135-2018-1, V, Ai).

In general, the effective amount of insect repellant can be used to indicate at least the presence of some remaining insect repellant after a number of wash cycle or can be used to specific a retention of the insect repellant. In an example implementation, an insect-resistant fabric in accordance with the disclosure can include a fabric or garment having an effective amount of the insect repellant after at least 3 wash cycles such as after at least 4, 5, 6, 7, 8, 9, 10, or greater than 10 wash cycles.

In one embodiment, for instance, greater than about 20% by weight, such as greater than about 30% by weight, such as greater than about 40% by weight, such as greater than about 50% by weight, such as greater than about 60% by weight, such as greater than about 70% by weight, such as even greater than about 80% by weight of the insect repellant remains on the fabric even after three laundry cycles.

For insect-resistant fabrics of the present disclosure, the concentration and/or relative amounts of active materials (e.g., the insecticide and the insect repellant) can be adjusted to produce various embodiments. As an example, federal guidelines have set targets for permethrin (an example insecticide) concentration in fabric of about 0.52%+/−10% on the weight of fabric. While this concentration has been deemed safe, embodiments of the disclosure can still demonstrate efficacy for insect resistance at lower concentrations of insecticide, due at least in part to the inclusion of an insect repellant. In particular, certain embodiments may demonstrate insect resistance efficacy without requiring the addition of an insecticide. Thus, for certain embodiments the concentration of the insecticide can be about 0% to about 10.52% based on the weight of the fabric or garment, such as about 0.5% to about 10%, about 1% to about 9%, about 2% to about 6%, or about 3% to about 5%.

Generally, insect repellants, in accordance with this disclosure, may be applied at higher concentrations as microencapsulation can provide extended release of the insect repellant without exposing a fabric wearer to concentrations that would negatively impact the wearer's health. In addition, certain repellants, such as essential oils, demonstrate lower toxicity or irritant properties compared to synthetic repellants. For some embodiments, the concentration of the insect repellant can be about 5.00 g/m² or less, such as 4.50, 4.00, 3.50, 3.00, 2.50, 2.00, 1.00, 0.90, 0.75, or 0.5 g/m². In certain embodiments, it may also be advantageous to produce an unscented fabric or garments, which may utilize a lower insect repellant concentration. Therefore, an example concentration range for the insect repellant in accordance with example insect-resistant fabrics and garments of the disclosure can be about 0.6 g/m² to about 3 g/m².

For both actives (e.g., the insect repellant and insecticide), loss or deactivation over time may lead to reduction in the concentration of each in the insect-resistant fabric. While certain embodiments of the disclosure can provide improved durability of insect-resistant materials, the concentrations of actives in insect-resistant fabrics of the disclosure may change or decrease over time without limiting the scope of these fabrics as embodiments. Additionally, concentrations of the actives can be determined based on the concentration present in a region of the fabric or garment (e.g., the first region) or based on the total area of the fabric or garment. For example, an insect-resistant fabric according to the disclosure may include a base fabric having a first region including an insect repellant having a concentration in the first region of less than or equal to about 5.00 g/m², and a second region overlapping some of the first region including an insecticide having a concentration of about 1.25 g/m² based on the total fabric area.

Insect-resistant fabrics of the present disclosure can demonstrate improved efficacy compared to fabrics that only contain an insecticide such as permethrin. For example, fabrics including a combination of an insect repellant and an insecticide can demonstrate about 300% improvement in bite protection when compared to fabrics only containing an insecticide. To state otherwise, fabrics or garments in accordance with the disclosure may reduce the number of insects landing on the fabric or garment by at least 300% when compared to insecticide-only fabrics. Thus, this disclosure also provides embodiments for enchasing the efficacy (e.g., bite protection) provided by a garment or fabric by incorporating an insect repellant into the fabric.

As an example, embodiments of the disclosure can include methods for treating a fabric to enhance bite protection. These methods can include administering a solution containing multiple microparticles to the fabric where some or all of the microparticle including an insect repellant. In some of these embodiments, a binding agent may also be applied to the fabric. Post-treatment, the fabric can display enhanced bite protection, such that using an arm-in-cage test, bite protection is improved by 300%.

Additional aspects of the disclosure can include methods for producing an insect-resistant fabric or garment. For example, a method for producing an insect-resistant fabric or insect-resistant garment in accordance with this disclosure can include applying a treatment to a base fabric or a garment. Generally, the treatment includes applying one or more solutions that together include an insecticide, an insect repellant, and a binding agent as described herein. Example methods are disclosed in further detail in Example 1: Methods: Impregnation methods.

In an example embodiment, applying the treatment can include immersing the base fabric in one solution that contains the insecticide, the insect repellant (in free solution and/or encapsulated in a microparticle), and the bonding agent.

In another example embodiment, applying the treatment can include spraying the base fabric or the garment with one solution, the one solution including the insecticide, the insect repellant, and the binding agent.

In general, methods for producing an insect-resistant fabric or insect-resistant garment can first include preparing the one or more solutions that together comprise an insecticide, an insect repellant, and a binding agent. Some of the methods according to the disclosure may require preparing only one solution containing the insecticide, the repellant, and the binding agent. In other methods, multiple solutions may be prepared that can then be applied to the fabric or garment in multiple steps that can independently include immersing, spray coating, or laundering.

An example aspect of preparing the one or more solutions can include an insecticide concentration, an insect repellant concentration, and a binding agent concentration. For instance, the insecticide concentration can range from about 0.25 wt % to about 8.0 wt %, such as about 0.5 to about 6.0, about 0.75 to about 4.0, about 0.8 to about 2.0, and about 0.85 to about 1.0 wt %. The insect repellant concentration can range from about 0.5 wt % to about 10.0 wt %, such as about 0.6 to about 7.0, about 0.8 to about 5.0, and about 1.0 to about 2.0 wt %. In some implementations, such as the production of unscented fabrics, the concentration of insect repellant can be about 0.9 to about 1.2 wt %. The binding agent concentration can range from about 0.1 wt % to about 8.0 wt %, such as about 0.25 to about 6.0, about 0.5 to about 4.0, and about 1.0 to about 3.0 wt %. As used herein, weight percentages (wt %) are determined based on the total weight of the solution containing the insecticide, the insect repellant, and/or the binding agent.

In accordance with embodiments of the disclosure, applying the treatment can include immersing the base fabric or the garment in a bath containing a first solution that includes the insecticide to produce a pre-treated material. The pre-treated material can then undergo an additional treatment such as drying to produce a treated material. Spray coating the treated material with a second solution containing the insect repellant and the binding agent can then be used to produce a fabric or garment impregnated with a combination of active ingredients in accordance with the disclosure.

In some embodiments, applying the treatment can also include heat-treating the resulting fabric or the garment after applying at least one of the one or more solutions. Heat-treating the resulting fabric or garment includes exposing the resulting fabric or garment to a temperature of about 75° C. to about 175° C., such as, 80° C. to about 160° C., 90° C. to about 150° C., or 100° C. to about 145° C.

### Example 1

Example 1 discusses various methods and procedures and provides exemplary embodiments that may be understood in conjunction with the Drawings and Description provided herein. The materials and methods described are not intended to limit the scope of materials and methods that may be used. Alternatives, generics, modifications, and extrapolations as would be understood by a person of ordinary skill are also contemplated as within the scope of this disclosure.

### Methods

### Materials

Insect repellant: A natural based mosquito repellent such as eucalyptus citriodora oil (1.0-2.5% OWB) and/or active ingredient of p-menthane 3,8-diol (0.5-1.5% OWB) were used in the mix emulsion to be applied to a fabric or garment using the methods below. These were encapsulated in an outer shell or purchased in an encapsulated form.

Insecticide: Permethrin (40% dispersion/emulsion) and technical grade (97% Concentration) are used in the formula in order to provides 0.52%±0.05 of permethrin per weight of treated fabrics. The exact amount of permethrin to be added depends on the type of fabric. Permethrin is a synthetic pyrethroid which has been approved for use by the US Environmental Protection Agency (EPA).

Binding agent: A heat-activated polyurethane binding agent was used (1-2.5% OWB) in order to prolong retention of permethrin through frequent wash cycles. A cross linker based on 3-glycidoxypropyltrimethoxysilane is used (1%-1.5% OWB) to improve adhesion between fibers and melamine microcapsules.

### Impregnation Methods

Method 1: Fabric can be polymer-coated with a combination of pyrethroid and insect repellent through one step conventional pad application, where the fabric is immersed in a liquid emulsion and then passed through nip rollers to remove excess amount of the finishing mix in order to yield desire wet pick up. The fabric was padded with 60-70% wet pick up and dried by process heating at 145° C. (293° F.).

Method 2: Fabric impregnation with pyrethroid through pad application (e.g., Method 1) followed by surface coating (e.g., spray coating) with insect repellent and dried by process heating at 145° C. (293° F.).

Method 3: Garment treatment with a combination of pyrethroid and insect repellent through one step impregnation process.

### Results

Results provided in the drawings and described herein are meant to be exemplary and are not intended to limit the methods and compositions to modifications or alternatives as would be understood by a person of ordinary skill in the field of endeavor.

### Bite Protection

The biting and landing protection of treated fabrics was evaluated by Arm-in-Cage testing. Total of 200 mosquitoes were transferred into the cage with a dimension of 30×45×45 cm (12×18×18 in). A forearm covered with treated fabric and the opposite arm covered with untreated fabric (control) were inserted to the cage. Protective gloves were used on hands for bite protection. The number of mosquito landing or probing was recorded during 15 minutes. Initial results using Anopheles quadrimaculatus in cage showed that Bite Protection % on a NyCo and Polyester fabric treated with a combination of Permethrin+PMD is 3 times higher than Bite Protection % on a permethrin only treated fabric.

### Durability

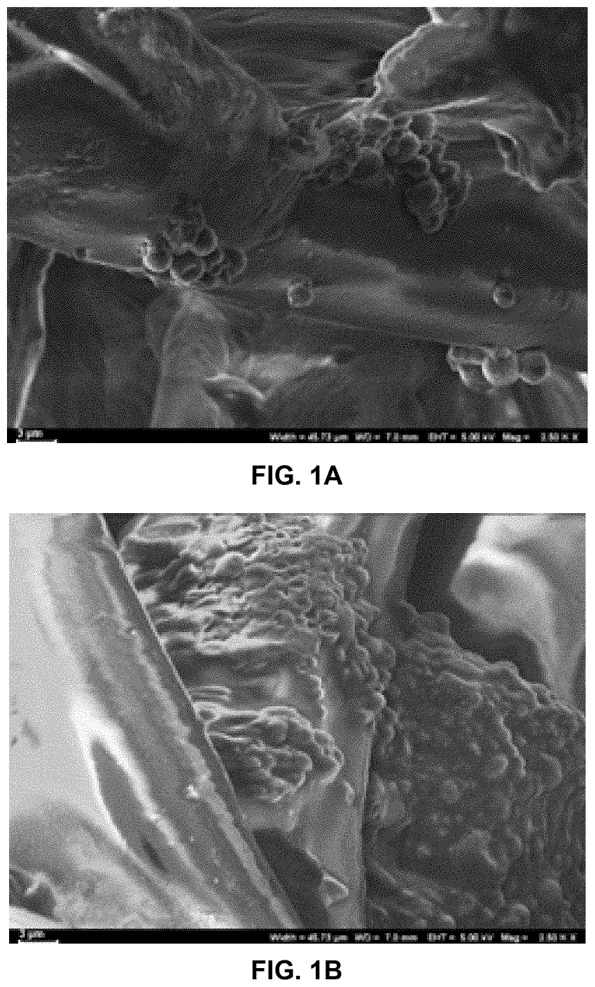

Referring now to FIGS. 1A and 1B, these figures show representative images displaying the microcapsules attached to fibers in a fabric after impregnation according to Method 1.

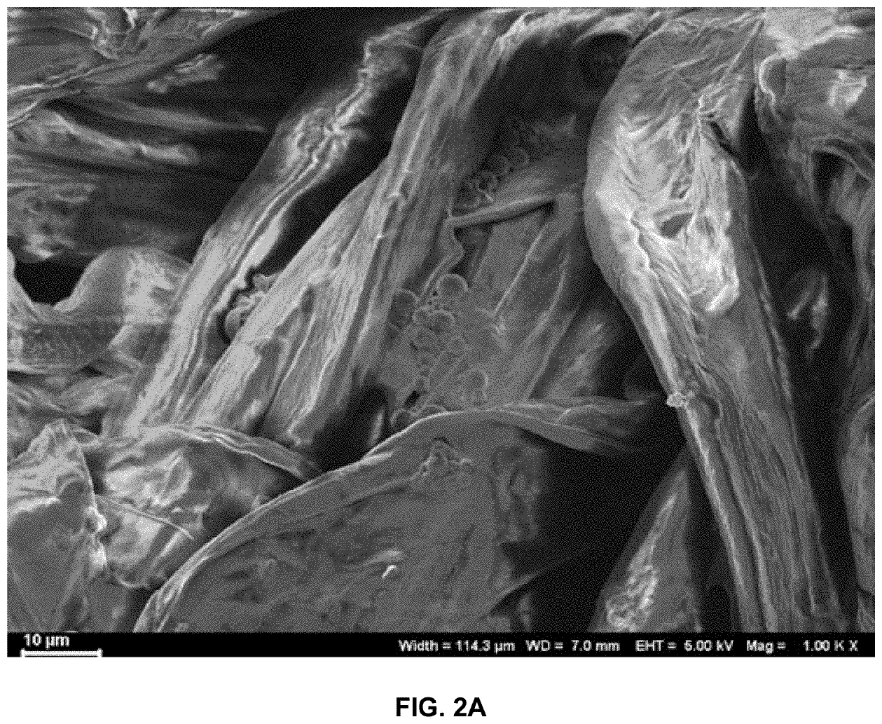

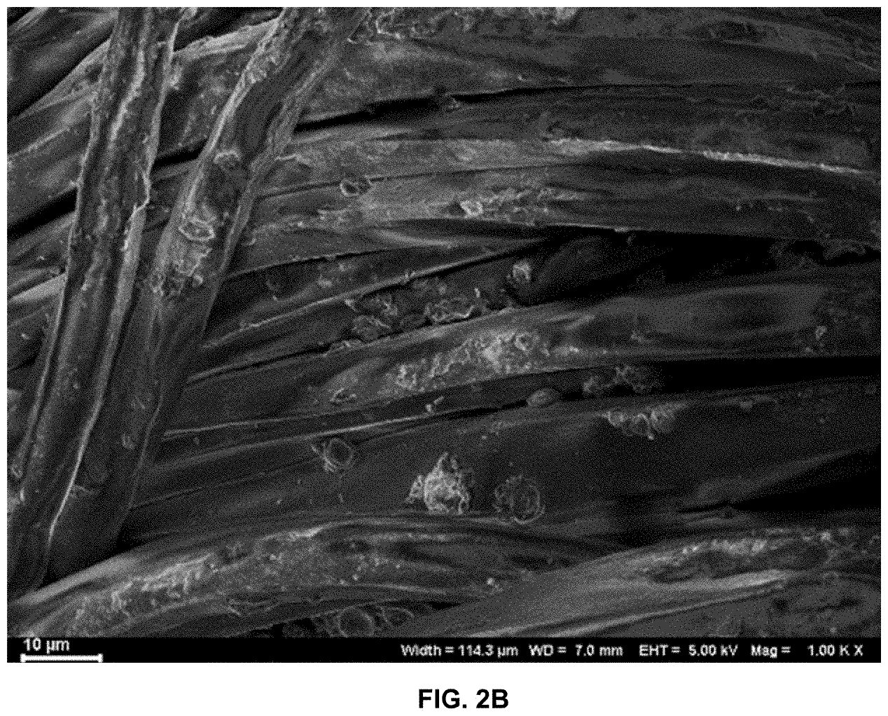

Referring to FIG. 2A, this figure shows a representative image of the same fabric displayed in FIGS. 1A and 1B after 30 days. Additional images of the fabric taken after 30 days demonstrate similar features showing the persistence of microcapsules on the fabric. Therefore, the microcapsules demonstrate durability over 30 or more days.

Referring to FIG. 2B, this figure shows a representative image of a fabric prepared according to Method 1 after undergoing 3 wash cycles. Microcapsules associated to the fibers by a binding agent are shown in the image indicating durability of impregnated fabrics on exposure to multiple wash cycles.

1. An insect-resistant fabric comprising:
a base fabric;
one or more insect repellants included in a first region of the base fabric; and
optionally, an insecticide included in a second region of the base fabric; wherein
the first region of the base fabric includes some, all, or none of the second region of the base fabric.

2. The insect-resistant fabric of claim 1, wherein the base fabric includes both the insect repellant and the insecticide.

3. The insect-resistant fabric of claim 2, wherein the insecticide comprises a pyrethroid compound.

4. The insect-resistant fabric of claim 3, wherein the pyrethroid compound comprises permethrin.

5. The insect-resistant fabric of claim 1, wherein the one or more insect repellants comprise p-menthane 3,8-diol.

6. The insect-resistant fabric of claim 1, wherein the one or more insect repellants comprise an essential oil.

7. The insect-resistant fabric of claim 6, wherein the essential oil includes one or more from the group consisting of: citronella, lemon eucalyptus, lavender, peppermint, sweet basil, catnip, tea tree, and sage.

8. The insect-resistant fabric of claim 1, wherein a portion of the one or more insect repellants is contained within a microcapsule.

9. The insect-resistant fabric of claim 8, further comprising at least one binding agent for retention of the insecticide, the one or more insect repellants, or both after a wash cycle.

10. The insect-resistant fabric of claim 9, wherein the at least one binding agent includes one or more from the group consisting of: a polyester polymer binder, a polyetheramide polymer binder, a polyurethane binder, a DMDHEU/polyol polymer, a cross-linking agent, and a dye fixative agent.

11. The insect-resistant fabric of claim 9, wherein an effective amount of the one or more insect repellants is present after at least 3 wash cycles.

12. The insect-resistant fabric of claim 9, wherein an effective amount of the one or more insect repellants is present after at least 10 wash cycles.

13. A method for producing an insect-resistant fabric or an insect-resistant garment comprising:
applying a treatment to a base fabric or a garment, wherein
the treatment includes applying one or more solutions that together comprise one or more insect repellants, optionally an insecticide, and a binding agent.

14. The method of claim 13, wherein applying the treatment comprises:
immersing the base fabric or the garment in a bath containing one solution, and
wherein the one solution comprises the insecticide, the insect repellant, and the binding agent.

15. The method of claim 13, wherein applying the treatment comprises:
immersing the base fabric or the garment in a bath containing a first solution, the first solution comprising the insecticide to produce a pre-treated material;
drying the pre-treated material to produce a treated material; and
spray coating the treated material with a second solution, the second solution comprising the insect repellant and the binding agent.

16. The method of claim 13, wherein applying the treatment comprises:
spray coating the fabric or the garment by spraying one solution, wherein the one solution comprises the insecticide, the insect repellant, and the binding agent.

17. The method of claim 13, wherein applying the treatment further includes heat-treating the resulting fabric or garment after applying at least one of the one or more solutions.

18. The method of claim 17, wherein heat-treating the resulting fabric or garment comprises exposing the resulting fabric or garment to a temperature of about 80° C. to about 175° C.

19. A method for treating a fabric to enhance bite protection, the method comprising:
administering a solution comprising a plurality of microcapsules and a binding agent to the fabric,
wherein at least one of the microcapsules contains an insect repellant, and wherein after treating the fabric, bite protection is improved 300% using an arm-in-cage test.

20. The method of claim 19, wherein the fabric comprises a base fabric and an insecticide.

21. The method of claim 20, wherein the insecticide comprises permethrin.
